(19) United States
(12) Patent Application Publication
(10) Pub. No.: US 2017/0230729 A1
(43) Pub. Date: Aug. 10, 2017

(54) MESSAGE CONTENT DELIVERY BASED ON USER INTERACTIONS

(71) Applicant: iHeartMedia Management Services, Inc., San Antonio, TX (US)

(72) Inventors: Eric J. Piard, Gainesville, FL (US); Shawn D. Maynard, Archer, FL (US); George R. Perez, Gainesville, FL (US)

(73) Assignee: iHeartMedia Management Services, Inc., San Antonio, TX (US)

(21) Appl. No.: 15/494,702

(22) Filed: Apr. 24, 2017

Related U.S. Application Data
(63) Continuation of application No. 12/412,313, filed on Mar. 26, 2009, now abandoned.

(51) Int. Cl. H04N 21/81; H04N 21/45; H04N 21/234; H04N 21/258

(52) U.S. Cl. CPC H04N 21/812; H04N 21/25891; H04N 21/4532; H04N 21/23424

(57) ABSTRACT

Individual user interactions with a social networking site, which indicate user engagement with particular commercial media content, can be tracked. User group data is generated from the user interactions. Message content related to the particular commercial media content, and schedule information indicating a time at which the particular commercial media content is scheduled for delivery, can be received. A message content delivery time can be determined based, at least in part, on the schedule information. At the message content delivery time, the message content can be delivered to users of the social networking site based, at least in part, on the user group data.

### CROSS-REFERENCE TO RELATED APPLICATIONS

The present U.S. Utility patent application claims priority pursuant to 35 U.S.C. §120 as a continuation of U.S. Utility application Ser. No. 12/412,313 entitled “DELIVERING CONTENT RELATED TO A COMMERCIAL MEDIA PROGRAM,” filed Mar. 26, 2009, all of which is hereby incorporated herein by reference in its entirety and made part of the present U.S. Utility patent application for all purposes.

### FIELD

The present disclosure relates generally to multimedia, and more particularly to providing content related to commercial media programs.

### BACKGROUND

Chatting agents and chat rooms that appeal to many different interests are currently available. These chat rooms are often dedicated to one or more particular topics, including broadcast television shows, and provide users a forum in which to discuss topics of interest with other interested users.

Consider, for example, a chat room dedicated to an episodic television show. Anyone can log onto the chat room to discuss, for example, the antics of a particularly interesting character, whether the show will continue along a certain plot line, or any other of countless topics of interest. Usually, there are no time restrictions on when users may log onto the chat room, so users may chat with each other when a television show is currently airing, or at other hours.

Chatting agents and related applications, therefore, essentially provide basic messaging functionality, but are not connected to media. These known arrangements are less than perfect.

### SUMMARY

A method, according to some embodiments, includes receiving, at a server, user group data and information indicating a time at which a selected segment of a commercial media program is to air on a first medium. The server also receives content related to the selected segment, and provides that content, via a second medium. The related content may be delivered, based on user group data, via the second medium to coincide, at least partially, with the time at which the selected segment is airing on the first medium.

The content may include interactive content, for example user selectable links to other related content, or non-interactive content. In some embodiments, the content may take the form of an interactive or non-interactive advertisement. If the content is interactive, one or more embodiments track at least one statistic indicative of a user interacting with the content. In some embodiments, information related to a number of users receiving the content is collected.

The server may provide a notification, indicating the time at which the commercial media program is to air. In some embodiments, Internet users may be provided a chat room related to the commercial media program.

Various embodiments include a system comprising a processor, a memory, and a program of instructions stored in memory, and configured to be executed by the processor. The program of instructions may be executed by the processor to implement one or more methods, including the methods discussed above. The system may also include servers to provide at least a portion of a broadcast playlist and content related to a selected segment of a broadcast commercial media program. Additionally, some embodiments may be implemented as a computer readable medium tangibly embodying a program of computer executable instructions. Other embodiments are also disclosed.

### BRIEF DESCRIPTION OF THE DRAWINGS

Aspects of this disclosure will become apparent upon reading the following detailed description and upon reference to the accompanying drawings, in which like references may indicate similar elements:

FIG. 1 depicts a high-level block diagram of a content delivery system;

FIG. 2 is a block diagram of a content server having various modules and client components to which the server may provide content;

FIG. 3 is a flow diagram illustrating delivery of related content;

FIG. 4 depicts a web browser and a television, and illustrates a timing relationship between content being delivered to a user and a segment of a commercial media program; and

FIG. 5 is a high level block diagram of a processing system.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Various embodiments described in this disclosure allow a person who knows about a television show via any of various information channels, to receive one or more notifications indicating when a program of interest will be aired. In addition, various ticklers can be provided, including information related to show content, sponsors, critic's reviews, and other desired information. In response to a notification or tickler, a chat room partner/viewer can log on to a chat room and chat with others who are authorized. Advertisements can be sent to a chat room partner/viewer based on marketing data, partner preferences, or other information. This data can be used to assess the likelihood that the chat room partner/viewer will be interested in, and react to, the advertisement. Additionally, promotional information may be selectively pushed out to viewers via computer readable media, a community forum such as Twitter, or other communications channel while chat room partners/viewers watch the television show.

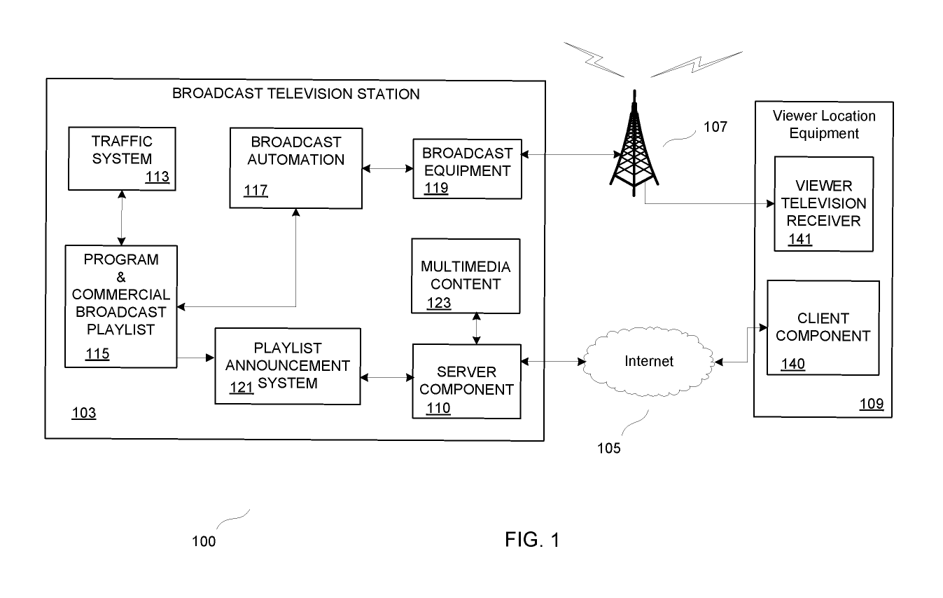

Referring first to FIG. 1, a high-level block diagram of a content delivery system is provided. Delivery system 100 includes, generally, broadcast television station 103, broadcast transmitter 107, network 105, and viewer location equipment 109. Broadcast television station 103 provides a commercial media program and content related to the commercial media program (“related content”). Broadcast television station 103 schedules the delivery of the commercial media program and the related content so that viewer television receiver 141 receives a selected segment of the commercial media program during at least a portion of time that client component 140 is receiving the related content.

As used herein, the phrase “commercial media program” refers to audio or video content, alone or in any combination, which includes identifiable segments. The segments may be, for example, entertainment content, educational content, and commercial content, and each segment may include additional identifiable segments. A commercial media program may be in analog or digital form, and may include a radio program, a television program, an Internet broadcast, or programming delivered via some other medium. A commercial media program may take the form of a program delivered only to selected recipients, for example a pay-per-view program, or be broadcast freely to anyone having the equipment to receive it.

Traffic system 113 can generate a program and commercial broadcast playlist (“playlist”) 115. Playlist 115 may include timing information indicating when a commercial media program is scheduled to air, and when particular segments of the commercial media program are scheduled to air. Broadcast automation equipment 117 uses playlist 115 to automate delivery of commercial media programs to broadcast equipment 119. Broadcast equipment 119 can send the commercial media programming to transmitter 107, which may transmit the commercial media program to viewer location equipment 109. Note that although transmitter 107 is illustrated as a broadcasting tower, in some embodiments, transmitter 107 may be another type of facility, such as a cable operator, an Internet service provider, a satellite transmission facility, or another type of broadcast facility.

In the illustrated embodiment, transmitter 107 can provide the commercial media program to viewer's television receiver 141. In one or more embodiments, the commercial media program that is received at viewer television receiver 141 includes segments of commercial content and programming content.

In addition, broadcast television station 103 can provide content related to selected segments of the commercial media program to client component 140. To accomplish this, broadcast television station 103 may obtain multimedia content 123 from any of a number of sources. For example, broadcast television station 103 may obtain multimedia content from one or more advertisers, or the broadcast television station 103 may generate multimedia content 123 using its own resources. Multimedia content 123 may include static, dynamic and interactive content, including audio only, video only, or a combination of audio, video and other types of media that can be transmitted over a network for receipt by viewer location equipment 109.

Broadcast television station 103 can also include playlist announcement system 121, which can obtain all or a portion of playlist 115 from traffic system 113. Server component 110 can obtain all or a portion of playlist 115 from playlist announcement system 121. In some embodiments, playlist announcement system 121 may be included in traffic system 113 or server component 110. Server 110 may also obtain a playlist, or a portion of a playlist, from a listing service (not illustrated) or other source.

Server component 110 can also access multimedia content 123, from another server component (not illustrated) located either locally or remotely, and may obtain all or a portion of multimedia content 123 from storage, or as it is generated. Thus, server component 110 may obtain content related to the commercial media programming from multimedia content 123, and timing information related to selected segments of the commercial media program from playlist announcement system 121. With this information, server component 110 may determine when to provide content related to a commercial media program to viewer location equipment 109, based on when selected segments of the commercial media program are to be aired. In some embodiments, the related content delivered to client component 140 is provided via the Internet 105, and can be received by client component 140 contemporaneously with a related segment of the commercial media program. Although FIG. 1 illustrates delivering related content via the Internet, other suitable networks, for example, a wireless data or telephone network (not illustrated) may be utilized.

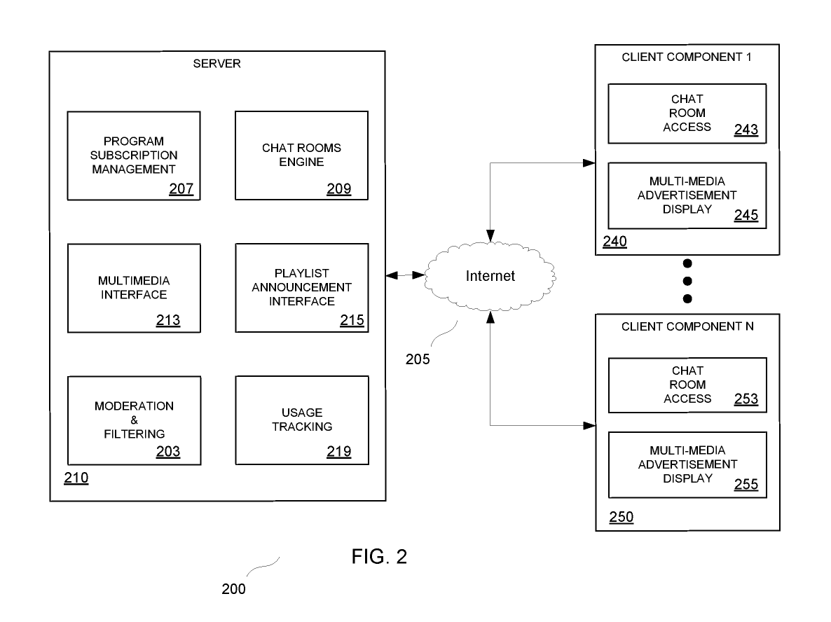

Referring next to FIG. 2, the operation of server 210 will be discussed in greater detail. FIG. 2 illustrates a system, 200, including a content server, server 210, having various modules, and client components 240 and 250, to which server 210 may provide content via a network, such as Internet 205. Server 210 includes program subscription management module 207, multimedia interface module 213, moderation and filtering module 203, chat rooms engine 209, playlist announcement interface 215, and usage tracking module 219. Client components 240 and 250 include chat room access modules 243 and 253, and multimedia advertisement displays 245 and 255, respectively. Server 210 may provide content related to specific portions and selected segments of a commercial media program to client components 240 and 250. Delivery of the related content is timed to coincide, at least partially, with delivery of selected segments of the commercial media program. In one or more embodiments, the related content and the commercial media program are delivered contemporaneously, utilizing different media.

Program subscription management module 207 may include group user data, and can be used to permit server 210 to restrict the delivery of related content, announcements, and other content to users who have subscribed to receive that content. A subscription may be a paid subscription, registration of an address to which the content is to be delivered, or involve other suitable subscription protocols. The phrase “user group data,” as used herein, can include data and information collected from subscribers, users, or other individuals or groups of individuals. It may include membership or subscription information, preferences, settings, information associated with media interactions and previous selections of interactive content.

Multimedia interface 213 can provide an interface that permits server 210 to receive multimedia content related to selected segments of a commercial media program. The content received by multimedia interface 213 may include, but is not limited to, advertising and promotional banners, clickable links, chat rooms content, video streams, file sharing, advertisements, links to additional content, video content, audio content, interactive games, or other types of multimedia content to be delivered to client components 240 and 250.

Chat room engine 209 can permit server 210 to provide chat room content to client components 240 and 250 based on user group data, or as otherwise desired. Chat room engine 209 may provide chat rooms configured for use by viewers of particular commercial media programs, so that viewers of that program may access and chat in a dedicated chat room. In some embodiments, chat room engine 209 can provide chat rooms dedicated to a particular television station, a particular advertiser, or the like. As used herein, the term “chat room” can include various social forums and networking sites, such as Twitter, Facebook, and the like. Moderation and filtering module 203 provides server 210 with functionality that prevents unwanted or undesirable content, and allows such content to be removed as necessary.

Usage tracking module 219 provides server 210 with the capability of tracking usage of chat rooms, and to track the degree and type of user interactions and decisions with content delivered to client components 240 and 250. Such decision monitoring can occur in a chat room or via other user actions. For example, the multimedia content delivered to client components 240 and 250 may include coupons, links to coupons, links to advertisements, or other content related to a commercial media program being displayed contemporaneously on television. Usage tracking module 219 also permits server 210 to gather data and collect demographic or other information associated with the provided content. In some embodiments, user tracking module 219 can generate user group data.

Playlist announcement interface 215 can enable server 210 to receive at least a portion of a broadcast playlist, which may indicate times when selected portions of a commercial media program are to be aired. With this information, server 210 can provide notifications to client components 240 and 250 indicating when a program is scheduled to begin, when a program is scheduled to end, when selected segments of a program are scheduled to air, or otherwise.

Client components 240 and 250 can include chat room access modules 243 and 253, and multimedia advertisement display 245 and 255, respectively. These modules allow client components 240 and 250 to access chat rooms provided by server 210 and to be provided with multimedia advertisement displays or other content related to a commercial media program. The content provided to client components 240 and 250 may be a function of a subscription level, a set of preferences, a chat room being accessed, a current location, or otherwise.

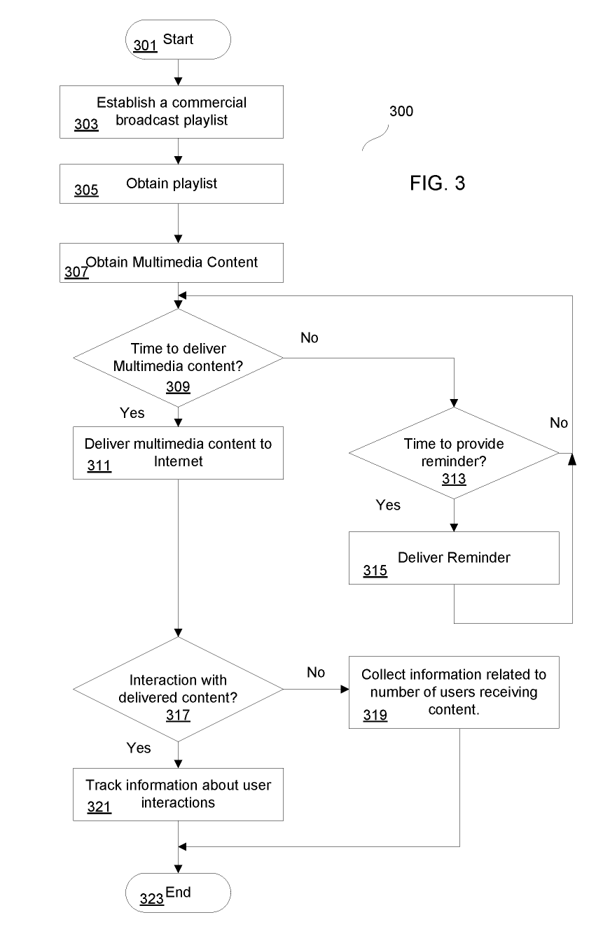

Referring next to FIG. 3, a method 300 according to one or more embodiments of the present disclosure is disclosed. Method 300 begins as illustrated by block 301 and proceeds as illustrated by block 303, were a commercial broadcast playlist can be established. The commercial broadcast playlist may include information about both commercial and programming content, including times commercials and other selected segments of the commercial media program are scheduled to air. As illustrated by block 305 at least a portion of the playlist established can be obtained. The portion of the playlist obtained may include the entire playlist, or less than the entire playlist. The playlist may include information related to selected segments for which related multimedia content is available. Thus, if selected segments of a commercial media program are to be linked, correlated, or otherwise related to multimedia or other content, information specific to the selected segments may be obtained as illustrated by block 305.

As illustrated by block 309, it can be determined whether it is time to deliver the multimedia content. This determination may be based on the portion of the playlist obtained, on user group data, or other suitable information. In some embodiments, as illustrated by block 309, it can be determined whether it is time to deliver multimedia content based upon whether related content is being concurrently provided via another medium. For example, a commercial media program being broadcast via television may include a commercial, and the multimedia content may be an interactive coupon, related to a television commercial, to be delivered via the Internet. In one or more embodiments, it can be determined whether a television commercial is currently airing, and if so a determination can be made that the time has come to deliver the interactive coupon or other multimedia content.

If it is determined, as illustrated by block 309, that it is not yet time to deliver multimedia content, for example because the television commercial is not yet airing, it can be determined whether it is time to provide a reminder. If it is determined, as illustrated by block 313 that a reminder is to be provided, the reminder can be delivered as illustrated in block 315. A reminder may be provided at various intervals prior to the occurrence of an event, or only a single reminder may be provided. The timing and form of reminder provided may be set by a broadcaster, by a content provider, an advertiser, user preferences, or otherwise.

If it is determined that multimedia content is to be delivered, the content can be delivered as illustrated by block 311. Any of various transmission methods and protocols may be used to deliver the content. For example, Hypertext Transport Protocol (HTTP) may be used to deliver the content via a packet switched wide area network such as the Internet. Other suitable protocols and transmission methods may also be utilized. In some embodiments, content can be delivered via various social forums and networking sites, such as Twitter, Facebook, and the like. The delivered content can include user selectable links related to content being broadcast via another medium, commercial content, programming content, contact information that allows a user to take an action in response to the delivered content, or other suitable types of content.

As illustrated by block 317, a check can be made for interaction with delivered content. If there has been no interaction with the delivered content, or if no interactive content was delivered, information related to the number of users receiving content can be collected, as illustrated by block 319. In addition to collecting information regarding the number of users receiving content, other types of data collection may also be implemented. For example, various statistics may be obtained or collected regarding demographics, subscription status of various users, user preferences, and the like.

If it is determined, as illustrated by block 317, that users have interacted with delivered content, information regarding user interactions can be tracked, as illustrated by block 321. The tracked information may include, for example, information about the number of times a user has interacted with delivered content, the content with which the user has interacted, reconciliation data for potential billing purposes, or other useful information. Method 300 ends as illustrated by block 323.

Although not illustrated, additional functionality may be included in method 300. For example, additional analysis may be performed on the information collected. Furthermore, data whether raw data, analyzed data, or a combination of both, may be provided to advertisers, or other interested parties, to allow them to determine the effectiveness of the content provided, and to aid in establishing advertising rates.

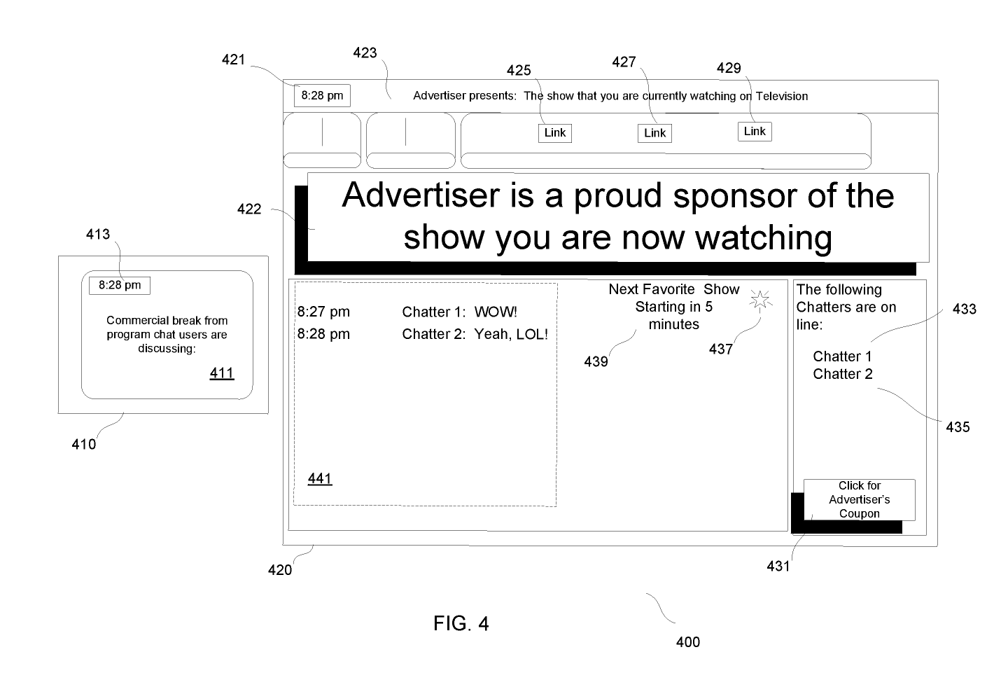

Referring next to FIG. 4, the relationship of selected segments of a commercial media program broadcast via a first medium to content provided via a second medium will be discussed. Diagram 400 includes, generally, a display 410 and a graphical user interface 420. Display 410 can be used to display a broadcast commercial media program, which includes commercial segment 411. Display 410 may be a personal digital assistant (PDA), a wireless telephone, a computer screen, a television, or other suitable display device. Clock 413, which indicates a time at which a commercial 411 is being displayed, may also be displayed on display 410. Note clock 413 is illustrated in FIG. 4 to draw attention to the timing relationship between the displayed commercial 411 and related content displayed on graphical user interface 420, and may not be displayed in all embodiments.

Graphical user interface (GUI) 420 may be displayed on any of various processing systems, including PDAs, personal computers, wireless telephones, or other suitable devices, and may be generated by a web browser running on such a processing system. In other embodiments, the general functionality and display of the graphical user interface may be provided by other means. GUI 420 includes clock 421, which indicates the same time as clock 413 on display 410; browser header 423, which displays content provided from an Internet server; and user selectable links 425, 427 and 429, which provide links to additional content which may or may not be related to a commercial media program being displayed on display 410.

GUI 420 also includes banner advertisement 422, which is related to the commercial 411 being displayed on display 410. Note that commercial 411 and the content of banner advertisement 422 are being displayed contemporaneously. In some embodiments, banner advertisement 422 may be displayed on GUI 420 for the entire time commercial 411 is being broadcast to display 410. In one or more embodiments, however, banner advertisement 422 is displayed contemporaneously with commercial 411 for a portion of the time commercial 411 is being broadcast. Banner advertisement 422 may also display content during a time when a program segment other than a commercial advertisement is airing. For example, metadata related to the program or program segment can be used to choose appropriate banner content to display at particular times. GUI 420 includes chat area 441, in which Chatter1 433 and Chatter2 435 may exchange messages via a network to which both have access.

Indicator 437 and reminder 439 may be used separately or in combination with each other to provide a user of GUI 420 with an indication that an event related to the commercial media program being broadcast to display 410 is about to occur. For example, reminder 439 and indicator 437 may be used to notify a user of GUI 420 that a television program, or a selected portion of a television program such as commercial 411, is about to air. Reminder 439 and indicator 437 may also be used to provide other useful notifications. Reminder 439 and indicator 437 are exemplary only, and various different types of indications may be used to provide notifications to a user, such as highlighting one or more portions of GUI 420, displaying various different shapes, audible indications, tactile indications delivered through various input and output peripherals such as gaming controllers, and the like.

Advertiser's coupon 431 is one example of content related to selected segments of a commercial media program being displayed concurrently on display 410. Advertiser's coupon 431 may change as the selected segment of the commercial media program being displayed on display 410 changes, such that advertiser's coupon 431 consistently reflects the commercial content being delivered to display 410.

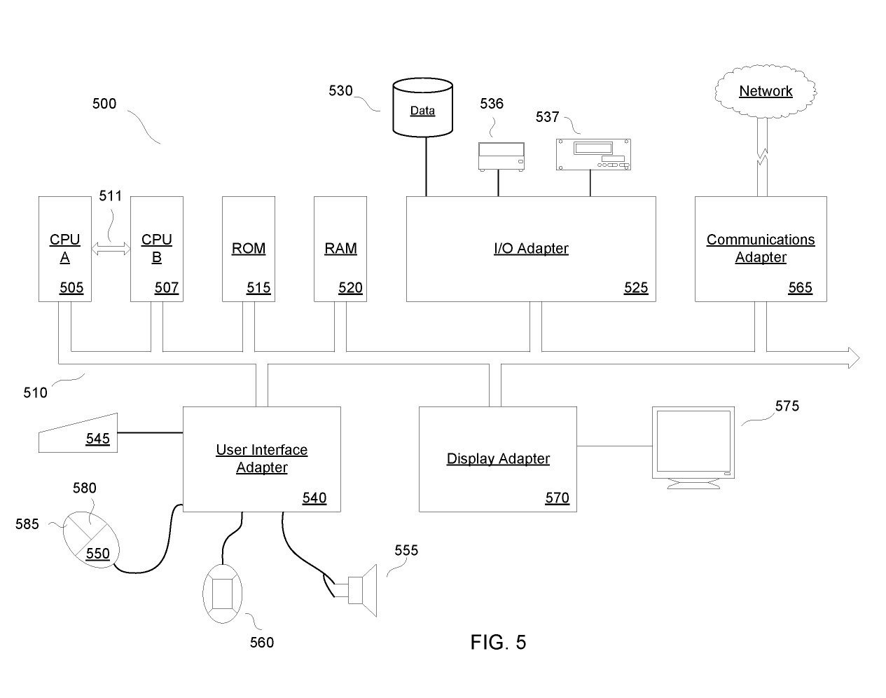

The methods and processes discussed previously, as well as other embodiments, may be implemented in a processing system executing a set of instructions stored in memory, or on a removable computer readable medium. An example of a system according to some embodiments is illustrated in FIG. 5. Referring now to FIG. 5, a high-level block diagram of a processing system is illustrated and discussed. Processing system 500 includes one or more central processing units, such as CPU A 505 and CPU B 507, which may be conventional microprocessors interconnected with various other units via at least one system bus 510. CPU A 505 and CPU B 507 may be separate cores of an individual, multi-core processor, or individual processors connected via a specialized bus 511. In some embodiments, CPU A 505 or CPU B 507 may be a specialized processor, such as a graphics processor, other co-processor, or the like.

Processing system 500 includes random access memory (RAM) 520; read-only memory (ROM) 515, wherein the ROM 515 could also be erasable programmable read-only memory (EPROM) or electrically erasable programmable read-only memory (EEPROM); and input/output (I/O) adapter 525, for connecting peripheral devices such as disk units 530, optical drive 536, or tape drive 537 to system bus 510; a user interface adapter 540 for connecting keyboard 545, mouse 550, speaker 555, microphone 560, or other user interface devices to system bus 510; communications adapter 565 for connecting processing system 500 to an information network such as the Internet or any of various local area networks, wide area networks, telephone networks, or the like; and display adapter 570 for connecting system bus 510 to a display device such as monitor 575. Mouse 550 has a series of buttons 580, 585 and may be used to control a cursor shown on monitor 575.

It will be understood that processing system 500 may include other suitable data processing systems without departing from the scope of the present disclosure. For example, processing system 500 may include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. In one or more embodiments, the invention is implemented in software, which includes but is not limited to firmware, resident software, microcode, etc. Some embodiments may be realized as a computer program product, and may be implemented as a computer-usable or computer-readable medium embodying program code for use by, or in connection with, a computer, a processor, or other suitable instruction execution system.

For the purposes of this description, a computer-usable or computer readable medium can be any apparatus that can contain, store, communicate, propagate, or transport the program for use by or in connection with the instruction execution system, apparatus, or device. By way of example, and not limitation, computer readable media may comprise any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Data structures and transmission of data (including wireless transmission) particular to aspects of the disclosure are also encompassed within the scope of the disclosure.

Various embodiments have been described for delivering content related to a commercial media program. Other variations and modifications of the embodiments disclosed may be made based on the description provided, without departing from the scope of the invention as set forth in the following claims.

What is claimed is:

1. A method comprising:
tracking, by a tracking module implemented by a server including a processor and associated memory, individual user interactions with a social networking site, the user interactions indicating user engagement with particular commercial media content;
generating, by the tracking module, user group data from the user interactions;
receiving, at the server, message content related to the particular commercial media content;
receiving, at the server, schedule information indicating a time at which the particular commercial media content is scheduled for delivery;
determining a message content delivery time based, at least in part, on the schedule information; and
at the message content delivery time, delivering the message content to users of the social networking site based, at least in part, on the user group data.

2. The method of claim 1, wherein the message content includes:
user selectable links to other content related to the particular commercial media content.

3. The method of claim 2, further comprising:
tracking at least one statistic indicative of a user interacting with the user selectable links.

4. The method of claim 1, further including:
tracking membership in groups associated with the particular commercial media content.

5. The method of claim 1, further including:
tracking media content with which individual users have interacted.

6. The method of claim 1, further including:
choosing particular message content based on metadata related to the particular commercial media content.

7. The method of claim 1, wherein the message content includes:
an indication that an event related to the particular commercial media content is scheduled to occur.

8. A system comprising:
a processor;
memory coupled to the processor;
a program of instructions stored in the memory and configured to be executed by the processor, the program of instructions comprising:
at least one instruction to track individual user interactions with a social networking site, the user interactions indicating user engagement with particular commercial media content;
at least one instruction to generate user group data from the user interactions;
at least one instruction to receive message content related to the particular commercial media content;
at least one instruction to receive schedule information indicating a time at which the particular commercial media content is scheduled for delivery;
at least one instruction to determine a message content delivery time based, at least in part, on the schedule information; and
at least one instruction to deliver, at the message content delivery time, the message content to users of the social networking site based, at least in part, on the user group data.

9. The system of claim 8, wherein the message content includes:
user selectable links to other content related to the particular commercial media content.

10. The system of claim 9, further comprising:
at least one instruction to track at least one statistic indicative of a user interacting with the user selectable links.

11. The system of claim 8, further including:
at least one instruction to track membership in groups associated with the particular commercial media content.

12. The system of claim 8, further including:
at least one instruction to track media content with which individual users have interacted.

13. The system of claim 8, further including:
at least one instruction to choose particular message content based on metadata related to the particular commercial media content.

14. The system of claim 8, wherein the message content includes:
an indication that an event related to the particular commercial media content is scheduled to occur.

15. A non-transitory computer readable medium tangibly embodying a program of computer executable instructions, the program of instructions comprising:
at least one instruction to track individual user interactions with a social networking site, the user interactions indicating user engagement with particular commercial media content;
at least one instruction to generate user group data from the user interactions;
at least one instruction to receive message content related to the particular commercial media content;
at least one instruction to receive schedule information indicating a time at which the particular commercial media content is scheduled for delivery;
at least one instruction to determine a message content delivery time based, at least in part, on the schedule information; and
at least one instruction to deliver, at the message content delivery time, the message content to users of the social networking site based, at least in part, on the user group data.

16. The non-transitory computer readable medium of claim 15, wherein the message content includes:
user selectable links to other content related to the particular commercial media content.

17. The non-transitory computer readable medium of claim 16, the program of instructions further including:
at least one instruction to track at least one statistic indicative of a user interacting with the user selectable links.

18. The non-transitory computer readable medium of claim 15, the program of instructions further including:
at least one instruction to track membership in groups associated with the particular commercial media content.

19. The non-transitory computer readable medium of claim 15, the program of instructions further including:
at least one instruction to track media content with which individual users have interacted.

20. The non-transitory computer readable medium of claim 15, the program of instructions further including:
at least one instruction to choose particular message content based on metadata related to the particular commercial media content.
